(19) United States
(12) Patent Application Publication
(10) Pub. No.: US 2007/0196660 A1
(43) Pub. Date: Aug. 23, 2007

(54) Decorative materials

(76) Inventor: Mary Boone Wellington, Nashua, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/361,030

(22) Filed: Feb. 23, 2006

(51) Int. Cl. B32B 27/30; B32B 27/20

(52) U.S. Cl. 428/409; 428/411.1; 428/522; 428/339; 428/913.3; 427/402

(57) ABSTRACT

The present invention relates to a decorative surfacing material and a method of providing such material. The decorative surface material may include a composite, which may be coated. The composite may be composed of one or more layers of a polymer. Each layer may be colorless or may be provided with a colorant or additive. The coating may include a microbial inhibitor.

### FIELD OF INVENTION

The present invention relates to a decorative material and providing a decorative material for the purpose of preparing unique ornamental designs for both commercial and residential surfacing applications. The decorative material may be treated to provide antimicrobial resistance.

### BACKGROUND

Numerous materials are available for residential and commercial surface applications. Surfacing materials may include both natural materials, such as granite or wood, and synthetic materials, such as polymeric materials. It is desirable to provide a surface material that is resistant to scratching, heat and stains, is easy to clean and is simple to maintain. Furthermore, it may be desirable to provide a surface material that is customizable, for example, a material that may be colorable to coordinate with the surrounding environment.

Various synthetic surface materials have been introduced. For example, acrylic materials have been available for some time. However, these materials may be prone to scratching and efforts have been made to improve scratch resistance. Non-acrylic materials have been made available as well, such as phenolics, formaldehydes or polyesters. Solid surface materials have also been made available and may include a base resin or resins in combination with fillers, such as quartz. However, there is still a need in the art to provide a surface that may be decorative, may provide relatively improved scratch resistance, may inhibit microbial growth and may exhibit brilliant colors.

### SUMMARY

An aspect of the present invention relates to a method of preparing a decorative material comprising providing a first reactive chemical component and curing the first reactive chemical component to a polymerized state. A second reactive chemical component may be applied to the first reactive chemical component and polymerized over a time period that so that diffusion of the second reactive component in the first component is in the range of about 0.01% to about 10% of the thickness of the first layer.

Another aspect of the present invention relates to a decorative material exhibiting comprising a first layer of a first material and a second layer of a second material disposed on the first layer to form a composite material, wherein the second layer has diffused in the range of about 0.01% to 10% of the thickness of the first layer.

### BRIEF DESCRIPTION OF DRAWINGS

The detailed description below may be better understood with reference to the accompanying figures which are provided for illustrative purposes and are not to be considered as limiting any aspect of the invention.

FIG. 1 is a cross-sectional view of an exemplary embodiment of a surface material.

### DETAILED DESCRIPTION

The present invention relates to a decorative material and providing a decorative material that is as functional as it is attractive. The decorative material may be formed of a material that lends itself to color modification. Furthermore, the decorative material may be treated to reduce bacterial or microbial growth.

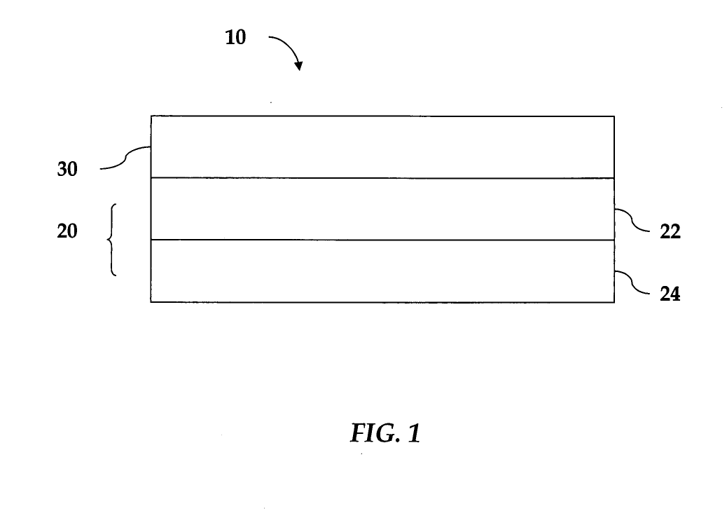

As illustrated in FIG. 1, the decorative material 10 may be composed of a polymeric material composite 20 and a coating layer 30. The polymeric composite 20 may include more than one layer, for example, the composite may include a first and second layer 22 and 24.

The polymeric material composite may include a thermoplastic or a thermoset material. The polymeric material may include a reactive chemical component such as an acrylic, polyester, polysulphone, poly-4-methyl-1-pentane, polyamide or polyurethane, etc. In an exemplary embodiment, the reactive chemical component may include a material having at least one acrylic functionality having the formula: C(R)H═CH—COOR′, wherein R comprises either a hydrogen, alkyl or aryl group, and R′ comprises either an alkyl or aryl group. The chemical components may be cured or polymerized and may crosslink upon cure or polymerization. The polymeric composite materials may also include additives such as inhibitors, accelerators, initiators, solvents and/or reactive solvents. In addition, other additives may be provided such as fillers and extenders, metallic flakes, metallic particles, quartz, clay, sand, etc.

The reactive chemical components may be provided in a colorless, i.e. transparent or translucent. In such a manner, the chemical components may have a refractive index in the range of about 1.3 to 1.6, including all values and increments therein. Furthermore, the chemical components may exhibit haze in the range of about 0.4 to 1%, including all values and increments therein. In addition, the chemical components may transmit visible light in the range of about 80% to 100%, including all values and increments therein.

The reactive chemical components may also include colorants. The colorants may include, for example, pigments or dyes, which may be provided in liquid, powder or granular form. The colorants may be present in the range of about 1 to 30% by weight of the chemical components, including all increments and values therebetween, such as 10%, etc.

The reactive chemical components material forming the polymeric composite material may be cast in a mold. The mold may be a single cell, which may produce a single sheet, or may include belts, which may produce continuous sheet. The mold may also be heated and/or pressurized. The chemical components may be supplied to the mold via supply lines. The chemical components may be mixed through static or dynamic mixers located in the supply lines or in mixing blocks.

Colorants and other additives may be added to the reactive chemical components via the supply lines, mixing blocks or added to the polymeric material once it is in the mold. The colorant may be combined with the chemical components and mixed until the color distribution is relatively uniform through out, or it may be combined with the chemical components in a manner which creates features and designs. Where supply lines are utilized, it may also be contemplated that the colorants or other additives may be introduced just prior to the addition of the reactive chemical component into the mold. For example an isolated zone incorporating a check valve to prevent back flow may be used. Such isolation may reduce the amount of waste material and reduce the exposure of the supply lines to colorants and additives.

In one exemplary embodiment, a first layer of a reactive chemical component including a colorant may be provided. The first layer may have a thickness of less than or equal to about one inch, including all increments and values therein, such as ½ inch, ¼ inch, etc. The first layer of chemical component may be cured to a polymerized state. Upon curing of the first layer, a second layer of a reactive chemical component may be formed over the first layer of polymeric composite material. The second layer may be less than or equal to about 1.25 inches, including all increments and values therein, such as ¼ inch, ½ inch, etc. The second layer may be colorless.

Accordingly, the second layer may be cured or polymerized over a time period wherein some diffusion of the second layer into the first layer across the interface of the layers may occur. For example, the second layer may diffuse into the first layer in the range of about 0.01% to 10% of the thickness of the first layer, including all increments and values therebetween. However, diffusion may be limited to the extent that the integrity of the desired color distribution in the first layer is minimally affected.

It should also be appreciated that while, in the above embodiment the formation of two layers, one including a colorant, is disclosed, more than two layers, with or without colorants or other additives, may be combined to form the polymeric composite. Wherein additional layers are desired, the additional layers may be deposited once the prior layer has been cured.

In another exemplary embodiment, the polymeric composite may be provided by supplying a first layer of a reactive chemical component that may be cast or extruded. The first layer may be less than or equal to about 1.25 inches, including all increments and values therein, such as ¼ inch, ½ inch, etc. This layer of material may be colorless, i.e., translucent or transparent.

A second layer of composite material including a colorant may be applied to the first layer. The second layer of material may be less than about one inch, including all increments and values therein such as ¼ inch, ½ inch, etc. The second layer may diffuse into the first layer in the range of about 0.01% to 10% of the thickness of the first layer, including all increments and values therebetween. However, diffusion may be limited to the extent that the integrity of the desired color distribution in the second layer is minimally affected.

Once again, while the above embodiment describes the formation of two layers, wherein one includes a colorant, is disclosed, more than two layers, with or without colorants or other additives, may be combined to form the polymeric composite.

One or more layers of the composite material may be sanded on one or both sides to provide a matte finish. By such, it is mean that the surface of composite layer that may be sanded to provide a non-glossy or dull surface. While the surface may remain translucent, such that the light may pass through the sheet, the light may be diffused so that objects on the other side may not be distinguiable. The sanding may be performed, for example, by an air or electric powdered random orbit sander. A 0.18 inch orbit pattern may be used, for example, with 80, 100, or 120 grit disks. Larger orbit equipment may also be utilized or the sanding machinery may be yoked together to improve production time. A vacuum may be applied to remove dust, as well as to maintain an exposed surface for sanding.

Accordingly, it should be appreciated that where the first layer of the composite material may be sanded, one or more surfaces of the first layer may be sanded prior to or after applying a second layer or more layers. The second layer may also be sanded in addition to or instead of the first layer. Similarly, additional layers may be sanded in addition to or instead of sanding the first or second layers.

Once the composite material including a desired number of layers and sanded surfaces has been formed, a coating material may be applied to the composite material. The coating may be about 0.001 inches to about 0.25 inches in thickness, including all increments and values therebetween. The coating material may be applied by brush, roller, spray, or any number of coating methods. Furthermore, the coating, once applied may be sanded or textured using a number of texturing techniques such as rag rolling, patting with a textured pad, etc. The coating composition may solidify due to the removal of solvent or upon exposure to heat.

The coating material may include a polyester compound, such as an alkyd. In an exemplary embodiment, alkyd oil based or latex based liquid coating composition may be employed. Additionally, wherein an alkyd oil based liquid is employed, an alkyd medium, such as a gel, may be combined with the oil based liquid. In such regard, the alkyd oil based liquid may be present in the range of about 1 to 99% by weight, including all increments and values therebetween, and the alkyd medium may be present in the range of about 1 to 99% by weight, including all increments and values therebetween.

The coating material may incorporate an additive, such as a biostabilizer or a microbial inhibitor, to inhibit microbial/bacterial activity. The additive may be, for example, mixed into the coating material. The additive may be organic or inorganic. In addition, the additive may be water soluble or oil soluble. The additives may be present in the range of about 0.001% to 10.0% by weight of the coating material, including all increments and values therebetween.

Exemplary additives include metal ions, such as silver ions, 10,10′-oxy-bis-phenoxarsin (I), N-(trihalogenomethylthio)-phthalimide (II) and corresponding tetrahydro derivative, diphenylstibine-2-ethylhexanoate (III), copper-bis-(8-hydroxyquinoline) (IV), tributyltin oxide and its derivatives (V), etc. Care should be taken, however, to choose a biostabilizer that is application compatible. For example, where the surface material may be used on a surface contacting food, a different biostabilizer may be more desirable than those used in bathroom, mudroom or industrial applications.

The foregoing description is provided to illustrate and explain the present invention. However, the description hereinabove should not be considered to limit the scope of the invention set forth in the claims appended here to.

What is claimed is:

1. A method of preparing a decorative material comprising:
providing a first reactive chemical component;
curing said first reactive chemical component to a polymerized state; and
applying a second reactive chemical component and polymerizing said second component over a time period that so that diffusion of said second reactive component in said first component is in the range of about 0.01% to about 10% of the thickness of the first layer.

2. The method of claim 1 wherein said first and second chemical components include at least one acrylic functionality having the formula: C(R)H═CH—COOR′, wherein R comprises either a hydrogen, alkyl or aryl group, and R′ comprises either an alkyl or aryl group.

3. The method of claim 1 further including applying a coating on said second polymerized reactive component.

4. The method of claim 3 wherein said coating includes a microbial inhibitor, wherein said microbial inhibitor is present in the range of about 0.001 to 10.0% by weight of said coating.

5. The method of claim 1 wherein said first component includes a colorant and said colorant is present in the range of about 1 to 30% by weight and said first component is present in the range of about 70 to 99% by weight.

6. The method of claim 1 wherein said second component includes a colorant and said colorant is present in the range of about 1 to 30% by weight and said second component is present in the range of about 70 to 99% by weight.

7. The method of claim 1 further comprising the step of providing a mold wherein said first component and second component are disposed.

8. The method of claim 1 wherein first component and second component are provided through supply lines, wherein said supply lines incorporate an isolated zone for the addition of additives or colorants.

9. The method of claim 1 wherein said first polymerized state includes a crosslinked polymer.

10. A decorative material exhibiting comprising:
a first layer of a first material; and
a second layer of a second material disposed on said first layer to form a composite material, wherein said second layer has diffused in the range of about 0.01% to 10% of the thickness of said first layer.

11. The decorative material of claim 10 including a coating disposed on said second layer of said decorative material.

12. The decorative material of claim 11 wherein said coating comprises about 0.001% to 10% by weight of an anti-microbial additive.

13. The decorative material of claim 10 wherein said first layer of said first material comprises about 1% to 30% colorant.

14. The decorative material of claim 10 wherein said second layer of said second material comprises about 1% to 30% colorant.

15. The decorative material of claim 10 wherein said first material includes at least one acrylic functional group having the formula: C(R)H═CH—COOR′, wherein R comprises either a hydrogen, alkyl or aryl group, and R′ comprises either an alkyl or aryl group.

16. The surface material of claim 10 wherein said second material includes at least one acrylic functional group having the formula: C(R)H₂═CH—COOR′, wherein R comprises either a hydrogen, alkyl or aryl group, and R′ comprises either an alkyl or aryl group.

17. The decorative material of claim 10 wherein said first layer of said first material comprises crosslinked polymeric material.

18. The decorative material of claim 10 wherein said first layer comprises a colorant and has a thickness of less than or equal to about 0.25 inches.

19. The decorative material of claim 10 wherein said second layer has a thickness of greater than or equal to about 0.25 inches.

20. The decorative material of claim 10 wherein said first layer has a thickness greater than about 0.25 inches and is colorless.
